(19) United States
(12) Patent Application Publication
(10) Pub. No.: US 2010/0176653 A1
(43) Pub. Date: Jul. 15, 2010

(54) BRAKE APPARATUS

(75) Inventor: Haruo ARAKAWA, Toyota-shi (JP)

Correspondence Address: BUCHANAN, INGERSOLL & ROONEY PC, POST OFFICE BOX 1404, ALEXANDRIA, VA, 22313-1404, US

(73) Assignee: ADVICS CO., LTD., Kariya-city (JP)

(21) Appl. No.: 12/685,431

(22) Filed: Jan. 11, 2010

(30) Foreign Application Priority Data
Jan. 13, 2009 (JP) 2009-004921

(51) Int. Cl. B60T 13/16

(52) U.S. Cl. 303/10

(57) ABSTRACT

A brake apparatus includes a master cylinder generating a master cylinder hydraulic pressure corresponding to a pressing operation to a brake pedal, a braking mechanism, a pressurizing mechanism generating a brake fluid pressure by use of a motor irrespective of the pressing operation, a control portion controlling an electric current applied to the motor corresponding to the pressing operation, a valve, a hydraulic pressure sensor detecting the brake fluid pressure generated by the pressurizing mechanism, and a failure determining portion executing a failure determination of the motor on the basis of the brake fluid pressure detected by the hydraulic pressure sensor by adjusting the degree of opening of the valve so as to be a interrupting position for interrupting the flow of the brake fluid pressure and by applying an electric current to the motor in order to generate the brake fluid pressure so as to be a predetermined pressure.

### CROSS REFERENCE TO RELATED APPLICATIONS

This application is based on and claims priority under 35 U.S.C. §119 to Japanese Patent Application 2009-004921, filed on Jan. 13, 2009, the entire content of which is incorporated herein by reference.

### TECHNICAL FIELD

This disclosure relates to a brake-by-wire type brake apparatus for a vehicle operated by an electronic control.

### BACKGROUND DISCUSSION

A brake apparatus known as a brake-by-wire type brake apparatus is in practical use. According to the brake-by-wire type brake apparatus, a force (e.g., pressure) applied to a brake pedal is converted to an electric signal, and a hydraulic pressure (e.g., a brake fluid pressure) is generated by an electronic control using the electric signal. Because such brake-by-wire type brake apparatus actuates a motor by means of the electronic control, any malfunction or failure of the motor needs to be appropriately detected.

For example, a brake apparatus disclosed in JP2008-174159A includes an electric motor and an electric braking force generator for braking a wheel of a vehicle by use of a driving force generated at the electric motor, in which a failure determination device sends an electrical signal to the electric motor such that the electric motor rotates in a direction opposite to that of the direction of rotation to generate a braking force. When a rotation of the electric motor is not detected, the failure determination device determines that a malfunction or a failure has occurred.

According to the brake apparatus disclosed in JP2008-174169A, because the electric motor rotates in the direction opposite that of the direction of rotation to generate the braking force, a piston of a slave cylinder is moved in a direction so as to reduce a hydraulic pressure. Accordingly, when a quick braking operation is executed at the time of an emergency, a time-lag may occur between the braking operation and the braking force generation.

A need thus exists to provide a brake apparatus which is not susceptible to the drawback mentioned above.

### SUMMARY

According to an aspect of this disclosure, a brake apparatus includes a master cylinder generating a master cylinder hydraulic pressure corresponding to a pressing operation to a brake pedal, a braking mechanism applying a braking force to a wheel by use of the master cylinder hydraulic pressure, a pressurizing mechanism generating a brake fluid pressure by use of a motor irrespective of the pressing operation to the brake pedal and applying the brake fluid pressure to the braking mechanism, a control portion controlling an electric current applied to the motor corresponding to the pressing operation to the brake pedal, a valve controlling a flow of the brake fluid pressure to the braking mechanism so as to be communicated or interrupted, a hydraulic pressure sensor detecting the brake fluid pressure generated by the pressurizing mechanism, and a failure determining portion executing a failure determination of the motor on the basis of the brake fluid pressure detected by the hydraulic pressure sensor by adjusting the degree of opening of the valve so as to be a interrupting position for interrupting the flow of the brake fluid pressure and by applying an electric current to the motor in order to generate the brake fluid pressure so as to be a predetermined pressure.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram indicating an overview of a brake apparatus related to a embodiment;

FIG. 2 is a diagram indicating a cross section of a pressurizing mechanism when a braking operation is not executed;

FIG. 3 is a diagram indicating a cross section of the pressurizing mechanism when a motor of the brake apparatus is correctly actuated upon the braking operation;

FIG. 4 is a diagram indicating a cross section of the pressurizing mechanism when the motor of the brake apparatus is not correctly actuated upon the braking operation;

FIG. 5A is a diagram indicating an engaging state of a clutch mechanism;

FIG. 5B is a diagram indicating another engaging state of the clutch mechanism;

FIG. 6A are diagrams indicating an engaging state between a stroke simulator and a housing;

FIG. 6B are diagrams indicating another engaging state between the stroke simulator and the housing; and

FIG. 7 is a flowchart indicating a control of the brake apparatus according to the embodiment.

### DETAILED DESCRIPTION

### First Embodiment

A first embodiment of a brake apparatus will be explained in accordance with attached drawings. The brake apparatus in the first embodiment includes a brake operation sensor BS, a braking mechanism C, a hydraulic pressure circuit 10, a master cylinder 30, a master reservoir 32, a pressurizing mechanism A and a control means B. The brake operation sensor BS measures a level of pressure (e.g., a pressing operation) applied to a brake pedal BP by a driver. The level of pressure will also be referred to as an operation amount at the brake pedal BP. The braking mechanism C is operated by a hydraulic pressure in order to apply a braking force to a wheel W, and the hydraulic pressure circuit 10 transmits the hydraulic pressure to the braking mechanism C. The master cylinder 30 generates the hydraulic pressure to a brake fluid in the hydraulic pressure circuit 10, the master reservoir 32 supplies the brake fluid to the master cylinder 30, the pressurizing mechanism A generates the hydraulic pressure (e.g., brake fluid pressure) at the master cylinder 30 (e.g., a master cylinder hydraulic pressure) corresponding to the pressing operation to the brake pedal BP, and the control means B applies an electric current to the pressurizing mechanism A, the level of the electric current being corresponding to the measured result of the brake operation sensor BS.

The braking mechanism C is configured with wheel cylinders WC (WCFR,WCFL,WCRR, and WCRL) and brake pads. The wheel cylinder WCFR Is provided at a front-right wheel WFR, the wheel cylinder WCFL is provided at a front-left wheel WFL, the wheel cylinder WCRR is provided at a rear-right wheel WRR, and the wheel cylinder WCRL is provided at a rear-left wheel WRL. Each of the brake pads is provided at each wheel (the front-right wheel WFR, the front-left wheel WFL, the rear-right wheel WRR and the rear-left wheel WRL) in order to generate a braking force caused by frictional force at the wheel on the basis of an actuation force of each of the wheel cylinders WC.

A master piston 31 is provided within the master cylinder 30 so as to be reciprocatable (e.g., execute a reciprocating movement) within the master cylinder 30. The hydraulic pressure of the brake fluid in the hydraulic pressure circuit 10 is generated by the reciprocating movement of the master piston 31 within the master cylinder 30. In the embodiment, the master cylinder 30 is arranged in tandem, and a first hydraulic pressure chamber 30a and a second hydraulic pressure chamber 30b are provided in the master cylinder 30. The master reservoir 32 includes two passages, and one of the passages connects the master reservoir 32 to the first hydraulic pressure chamber 30a, and the other of the passages connects the master reservoir 32 to the second hydraulic pressure chamber 30b.

The hydraulic pressure circuit 10 is configured with a first hydraulic pressure circuit 10a and a second hydraulic pressure circuit 10b, each of which is connected to the master cylinder 30. The first hydraulic pressure circuit 10a communicates the first hydraulic pressure chamber 30a with the rear-right wheel cylinder WCRR and the rear-left wheel cylinder WCRL, and the second hydraulic pressure circuit 10b communicates the second hydraulic pressure chamber 30b with the front-right wheel cylinder WCFR and the front-left wheel cylinder WCFL.

More specifically, the first hydraulic pressure circuit 10a is configured with a first branched passage 11a and a second branched passage 15a, and the first branched passage 11a is connected to the rear-right wheel cylinder WCRR and the second branched passage 15a is connected to the rear-left wheel cylinder WCRL. A first normally opened control valve 12a is provided at the first branched passage 11a. The first normally opened control valve 12a is normally opened and is switchable to be in a communicating position or an interrupting position. Further, a first check valve 14a is provided so as to be parallel to the first normally opened control valve 12a in order to permit the flow of the brake fluid from the rear-right wheel cylinder WCRR to the pressurizing mechanism A but prohibits the flow of the brake fluid from the pressuring mechanism A to the rear-right wheel cylinder WCRR. A second normally opened control valve 16a is provided at the second branched passage 15a. The second normally opened control valve 16a is normally opened and is switchable to be in a communicating position or an interrupting position. Further, a second check valve 18a is provided so as to be parallel to the second normally opened control valve 16a in order to permit the flow of the brake fluid from the rear-left wheel cylinder WCRL to the pressurizing mechanism A but prohibits the flow of the brake fluid from the pressuring mechanism A to the rear-left wheel cylinder WCRL.

A passage branched from the first branched passage 11a at a point closer to the rear-right wheel cylinder WCRR relative to the first normally opened control valve 12a and a passage branched from the second branched passage 15a at a point closer to the rear-left wheel cylinder WCRL relative to the second normally opened control valve 16a are merged so as to form a merging passage 19a. The merging passage 19a is connected to a branching point at which the first branched passage 11a and the second branched passage 15a are branched from the first hydraulic pressure circuit 10a. Further, a first normally closed control valve 13a is provided at the passage branched from the first branched passage 11a, which is a part of the merging passage 19a, and a second normally closed control valve 17a is provided at the passage branched from the second branched passage 15a, which is also a part of the merging passage 19a. Each of the first normally closed control valve 13a and the second normally closed control valve 17a is normally closed and is switchable to be in a communicating position or an interrupting position. A passage of the merging passage 19a extending from the first normally closed control valve 13a and a passage of the merging passage 19 extending from the second normally closed control valve 17a meet at an interflow point, and a third check valve 20a, a hydraulic pressure pump 21a and a fourth check valve 22a are provided in the mentioned order at the merging passage 19a from the interflow point to the branching point at which the first branched passage 11a and the second branched passage 15a are branched from the first hydraulic pressure circuit 10a. The hydraulic pressure pump 21a is driven by a motor CM so as to discharge (e.g., output) the brake fluid. A reservoir 23a is provided between the third check valve 20a and both of the first normally closed control valve 13a and the second normally closed control valve 17a.

The second hydraulic pressure circuit 10b has a similar structure to the first hydraulic pressure circuit 10a and includes similar passages, valves and the like. The passages, the valves and the like are indicated by identical numbers to that of the first hydraulic pressure circuit 10a in which an alphabet “a” is replaced by “b”. Because the second hydraulic pressure circuit 10b has a similar configuration to that of the first hydraulic pressure circuit 10a, detailed explanations are omitted, and the alphabet “a” or “b” may be abbreviated in the following explanations.

The motor CM drives both of the hydraulic pressure pump 21a of the first hydraulic pressure circuit 10a and the hydraulic pressure pump 21b of the second hydraulic pressure circuit 10b.

A master cylinder hydraulic pressure sensor 24 is provided at the second hydraulic pressure circuit 10b in order to measure a hydraulic pressure of the master cylinder 30 (e.g., the master cylinder hydraulic pressure).

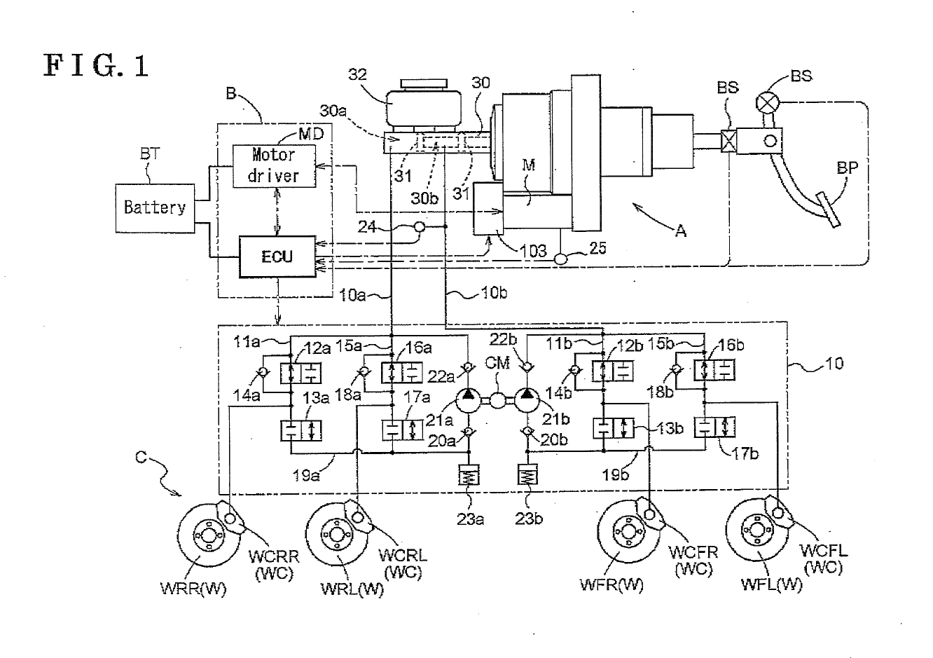

As illustrated in FIG. 1, the brake apparatus of the embodiment includes the control means B. The control means B is configured with an electric control unit (ECU) including a microcomputer as a core and a motor driver MD for applying an electric current to the pressurizing mechanism A. Further, a battery BT is connected to each of the ECU and the motor driver MID. The control means B controls a motor M and the valves provided at the hydraulic pressure circuit 10 in order to control a level of the braking force applied to the wheel W. The brake apparatus according to the embodiment is a brake-by-wire type brake apparatus, and the control means B applies an electric current corresponding to the operation amount of the brake pedal BP to the pressurizing mechanism A on the basis of an output indicating the operation amount of the brake pedal BP measured by the brake operation sensor BS. In this embodiment, because a level of a stroke of the brake pedal BP and a level of the pedal pressure (e.g., the pressing operation) applied to the brake pedal BP by the driver are detected as the operation amounts, a stroke sensor and a pedal pressure sensor are used as the brake operation sensor BS.

The control means B controls the braking force applied to the wheels W as follows. In a case where the braking force is applied to the wheel W, in other words in a case where a pressure within the wheel cylinder WC is increased, the first normally opened control valve 12a and the like are switched so as to be in the communicating positions, and the first normally closed control valve 13a and the like are switched so as to be in the interrupting positions. On the other hand, in a case where the level of the braking force of the wheel W is decreased, in other words in a case where the pressure within the wheel cylinder WC is decreased, the first normally opened control valve 12a and the like are switched so as to be in the interrupting positions, and the first normally closed control valve 13a and the like are switched so as to be in the communicating positions. Further, the level of the braking force of the wheel W is maintained at a desired level, in other words in a case where the level of the pressure within the wheel cylinder WC is maintained, the first normally opened control valve 12a and the like and the first normally closed control valve 13a and the like are switched so as to be in the interrupting positions.

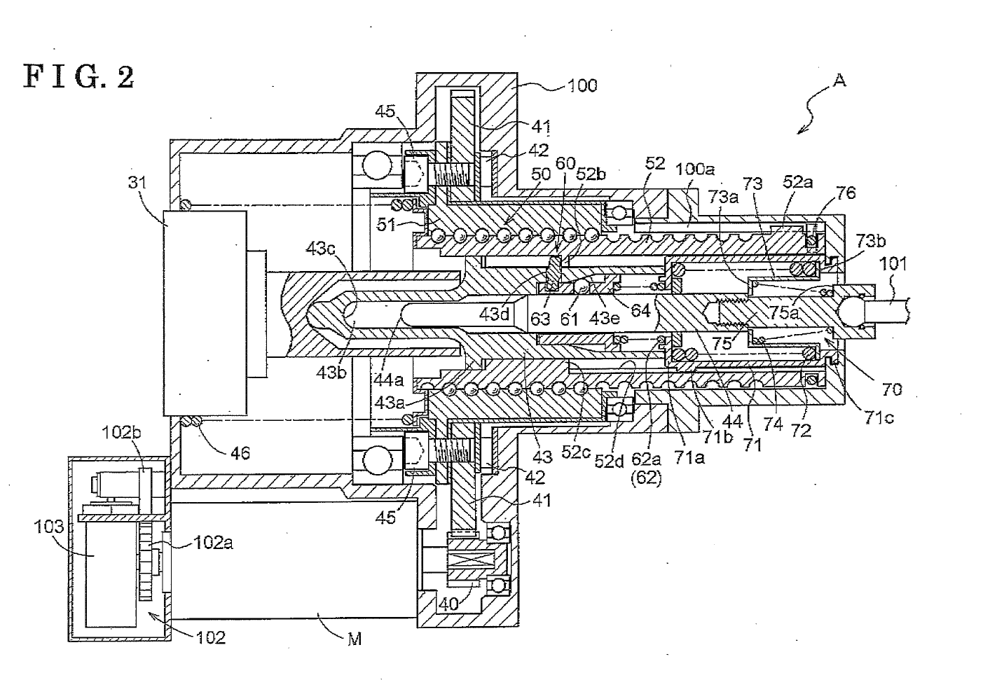

FIG. 2 illustrates a configuration of the pressurizing mechanism A of the brake apparatus. The pressurizing mechanism A includes the motor M, a first spur gear 40, a second spur gear 41, a moving direction converting mechanism 50, an output piston 43, an input rod 44, stroke simulator 70 and an elastic member 46. The motor M rotates corresponding to a level of the electric current applied thereto by the control means B, the first spur gear 40 integrally rotatable with a rotation shaft of the motor M, teeth formed on the second spur gear 41 so as to be engaged with teeth of the first spur gear 40, and a number of the teeth of the second spur gear 41 being greater than that of the first spur gear 40. The moving direction converting mechanism 50 whose axis is identical to that of the second spur gear 41 is provided in a gear hole (e.g., an opening) of the second spur gear 41, and a rotation of the second spur gear 41 is converted to a movement in a reciprocating direction of the master piston 31. The output piston 43 is inserted into a cylindrical hole of the moving direction converting mechanism 50 so as to be movable in the reciprocating direction of the master piston 31. The input rod 44 is connected to the brake pedal BP by means of the shaft 101 and is movable in the reciprocating direction of the master piston 31 corresponding to the operation amount of the brake pedal BP. The stroke simulator 70 applies a reaction force to the brake pedal BP in accordance with a moving amount in a reciprocating direction of the input rod 44, and the elastic member 46 biases the moving direction converting mechanism 50 in the reciprocating direction of the master piston 31. Hereinafter, the directions of the reciprocating movement of the master piston 31 are expressed as a forward direction and a rearward direction. Specifically, the direction in which the master piston 31 is moved so as to apply a pressure to the brake fluid is expressed as the forward direction, and the direction in which the master piston 31 is moved so as to reduce the pressure of the brake fluid is expressed as the rearward direction.

The moving direction covering mechanism 50 includes a rotating member 51 and a linearly moving member 52. The rotating member 51 is inserted into the gear hole of the second spur gear 41 so as to have an identical axis thereto and so as to integrally rotate therewith wile being regulated so as not to move in the reciprocating direction. The linearly moving member 52 is inserted into the cylindrical hole of the rotating member 51 so as to have and identical axis thereto and so as to be movable in the reciprocating direction. The second spur gear 41 and the rotating member 51 are integrated by means of a fixing member 45, and the rotating member 51 is integrally rotated in accordance with the rotation of the second spur gear 41. The second spur gear 41 is rotatably fixed to a housing 100 by means of the thrust bearing 42. The linearly moving member 52 is engaged with a rotation regulating portion 100a of the housing 100 so as to be thrust-movable and so as to transmit the rotational force to the rotation regulating portion 100a by means of a thrust engagement portion 52a. In the embodiment, the engagement between the linearly moving member 52 and the rotation regulating portion 100a of the housing 100 is referred to as a thrust engagement. Further, an external thread is formed on an outer circumferential surface of the linearly moving member 52, and an internal thread is formed on an inner circumferential surface of the rotating member 51. The linearly moving member 52 is arranged so as to be screwed in the rotating member 51. In this embodiment, small ball bearings are provided between the internal thread and the external thread. In this configuration, in accordance with the rotation of the rotating member 51, the linearly moving member 52 starts its rotation, however, because the thrust engagement portion 52a engages the rotation regulating portion 100a, the linearly moving member 52 is regulated so as not to rotate, and then the linearly moving member 52 is moved in the reciprocating direction.

Further, the output piston 43 is inserted into a cylindrical hole of the linearly moving member 52 so as to have an axis identical to that of the linearly moving member 52. On an inner surface of the cylindrical hole of the linearly moving member 52 in a radial direction thereof, a thrust force transmitting portion 52c is formed in order to transmit a thrust force in a forward direction to the output piston 43, and on an outer circumferential surface of the output piston 43 in a radial direction thereof, a thrust force receiving portion 43a is formed in order to receive the thrust force from the thrust force transmitting portion 52c. As illustrated in FIG. 2, when the pressurizing mechanism A is not actuated, a clearance is formed between a thrust force transmitting portion 52c and a thrust force receiving portion 43a in the reciprocating direction. When the linearly moving member 52 is moved in the forward direction, the clearance is reduced, and the thrust force transmitting portion 52c eventually contacts the thrust force receiving portion 43a. Then the linearly moving member 52 and the output piston 43 are integrally moved forward. The housing 100 has an opening in the direction of the master cylinder 30, and an end portion of the master piston 31 is positioned so as to protrude from the opening. When the output piston 43 is moved forward, the end portion of the master piston 31 is pushed by the output piston 43 so that the brake fluid within the master cylinder 30 is pressurized, and the hydraulic pressure is transmitted to the wheel cylinder WC through the hydraulic pressure circuit 10.

The output piston 43 includes a hollow portion 43b opening to the opposite side of where the master cylinder 30 is positioned, and the input rod 44 is inserted into the output piston 43 through the opening thereof (the hollow portion 43b). As illustrated in FIG. 2, an end portion 44a of the input rod 44 at the side of the master cylinder 30 is distant in a predetermined length from a bottom surface 43c of the hollow portion 43b of the output piston 43. At the time of a normal braking operation, in accordance with the pressing operation to the brake pedal BP, the input rod 44 is moved forward toward the master cylinder 30, at the same time, the output piston 43 is also moved forward by the rotation of the motor M. Accordingly, the end portion 44a of the input rod 44 does not press the bottom surface 43c of the hollow portion 43b of the output piston 43. Specifically, the pressing operation to the brake pedal BP is not directly transmitted to the master piston 31 and is transmitted indirectly by means of the electric current applied to the motor M on the basis of the operation amount of the brake pedal BP. The input rod 44 and the output piston 43 are operated so as to be connected/disconnected to/from each other by means of the clutch mechanism 60. In this configuration, a brake-by-wire type brake operation is achieved.

While the motor M is appropriately actuated, the brake-by-wire type brake apparatus may perform its function, however, when the motor M is not actuated due to its malfunction or failure, the brake-by-wire type brake apparatus may not perform its function. Accordingly, when the motor M is not actuated, the pressing operation to the brake pedal BP by the driver needs to be directly transmitted to the output piston 43. In order to directly transmit the pressing operation at the brake pedal BP to the output piston 43, the brake apparatus in the embodiment further includes a clutch mechanism 60.

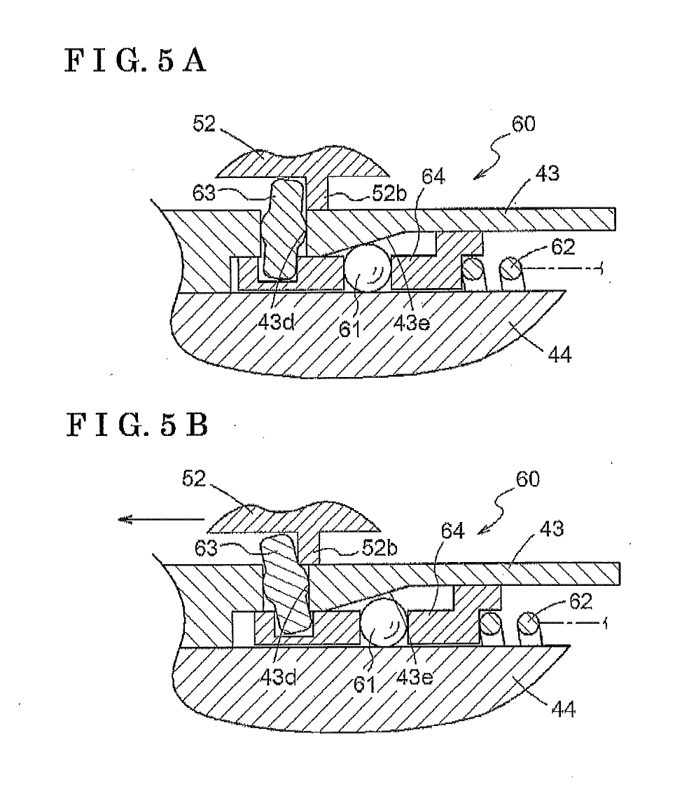

The clutch mechanism 60 controls the input rod 44 and the output piston 43 so as to be connected/disconnected to/from each other in accordance with the driving condition of the motor M. As indicated in the drawings of FIGS. 2 and 5, on a cylindrical portion of the output piston 43, an opening portion 43d is formed so as to communicate (e.g., connect) between the hollow portion 43b and the inner surface of the linearly moving member 52. The clutch mechanism 60 includes the tapered surface 43e, a rotating body 61, a biasing body 62, a link member 63, a fixing member 64 and an inwardly protruding portion 52b. The tapered surface 43e is formed on an inner wall surface of the hollow portion 43b of the output piston 43, the rotating body 61 is arranged between the tapered surface 43e and an outer surface of the input rod 44, and the biasing body 62 is provided in order to bias the rotating body 61 so as to contact the tapered surface 43e and the outer surface of the input rod 44. The link member 63 is arranged so as to be inserted into the opening portion 43d, be supported by side wall surfaces (e.g., surfaces forming the opening portion 43d) of the output piston 43, be positioned so as to protrude toward both of the linearly moving member 52 and the input rod 44, and be pivotally in the reciprocating direction. The fixing member 64 is formed so as to support the rotating body 61 and includes a recessed portion into which the, end portion of the link member 63 at the side of the input rod 44 is fitted. The inwardly protruding portion 52b is formed at the linearly moving member 52 in order to push the link member 63 in the front direction when the linearly moving member 52 is moved in the front direction. An end portion 62a of the biasing body 62 at the side of the stroke simulator 70 is fixed to a bottom 71a of a first casing 71 of the stroke simulator 70. A plurality of the rotating bodies 61 and the link members 63 are provided in a circumferential direction, and a plurality of the inwardly protruding portions 52b is formed so as to correspond to the link members 63, and a plurality of the holes of the fixing member 64 is provided so as to correspond to the rotating bodies 61.

In this configuration, the clutch mechanism 60 disengages the input rod 44 from the output piston 43 when the motor M is actuated, and the clutch mechanism 60 engages the input rod 44 with the output piston 43 so as to be integrally movable in the front direction when the motor M is not actuated. Thus, the function of the brake-by wire type brake apparatus is completed when the motor M is actuated, and the pedal pressure is directly transmitted from the brake pedal BP to the master cylinder 30 when the motor M is not actuated. The operation of the clutch mechanism 60 will be explained below in detail.

According to the abovementioned brake-by-wire type brake apparatus, a reaction force may not be generated by the master piston 31 even when the driver presses the brake pedal BP, thereby providing the driver with an uncomfortable feeling. Normally, according to the brake-by-wire type brake system, a stroke simulator is used in order to reduce the uncomfortable feeling. Specifically, the stroke simulator generates a reaction force corresponding to the stroke amount of the brake pedal BP in order to provide the driver with a sense of braking operation.

The stroke simulator 70 in the embodiment is formed so as to have a two-layered structure as illustrated in the drawing of FIG. 2. The stroke simulator 70 includes the first casing 71, a second casing 73, a first elastic member 72, a second elastic member 74 and a connecting member 75. The first casing 71 forms an outer shape of the stroke simulator 70 and includes the bottom 71a and a cylindrical portion. An opening is formed on the bottom 71a of the first casing 71, and the input rod 44 is provided so as to penetrate through the opening of the bottom 71a. The first elastic member 72 is provided inside the first casing 71 so as to contact an inner surface of the cylindrical portion of the first casing 71, and one end portion of the first elastic member 72 contacts the bottom 71a of the first casing 71. The second casing 73 provided within the first casing 72 is formed so as to have a bottom 73a, a cylindrical portion and a brim portion 73b. An opening is formed on the bottom 73a of the second casing 73, and the connecting member 75 is provided so as to penetrate through the opening of the bottom 73a. The first elastic member 72 is arranged so as to contact at the other end portion thereof to the brim portion 73b. The connecting member 75 penetrating through the second casing 73 is screwed into the input rod 44 in order to transmit the thrust force of a shaft 101 moving forward to the input rod 44. Further, the second elastic member 74 is provided within the second casing 73 in a manner where one end portion of the second elastic member 74 contacts an inner surface of the bottom 73a of the second casing 73, and the other end portion of the second elastic member 74 contacts a brim portion 75a of the connecting member 75.

In this embodiment, the first elastic member 72 and the second elastic member 74 are coil springs, and a spring constant of the second elastic member 74 is set to be smaller than that of the first elastic member 72. Accordingly, at an initial phase of the pressing operation to the brake pedal BP by the driver, the second elastic member 74 generates a small reaction force, and then the first elastic member 72 generates a large reaction force, thereby providing a similar reaction force generated by a known disc brake, as a result, the driver may not feel the uncomfortable feeling.

As described above, because the stroke simulator 70 is used for the brake-by-wire type brake system in order to generate the reaction force corresponding to the pressing operation to the brake pedal BP to the driver, the reaction force needs to be generated by the stroke simulator 70 when the brake apparatus is actuated so as to appropriately achieve the function of the brake-by-wire type brake apparatus. However, according to the embodiment, because the pedal pressure applied to the brake pedal BP is directly transmitted to the master piston 31 when the motor M is not actuated, corresponding reaction force is transmitted to the brake pedal BP. At this point, the driver may need to press the brake pedal BP twice as much as usual. In order to avoid such inconvenience, the stroke simulator 70 of the brake apparatus according to the embodiment is disengaged from the housing 100 when the motor M is not actuated.

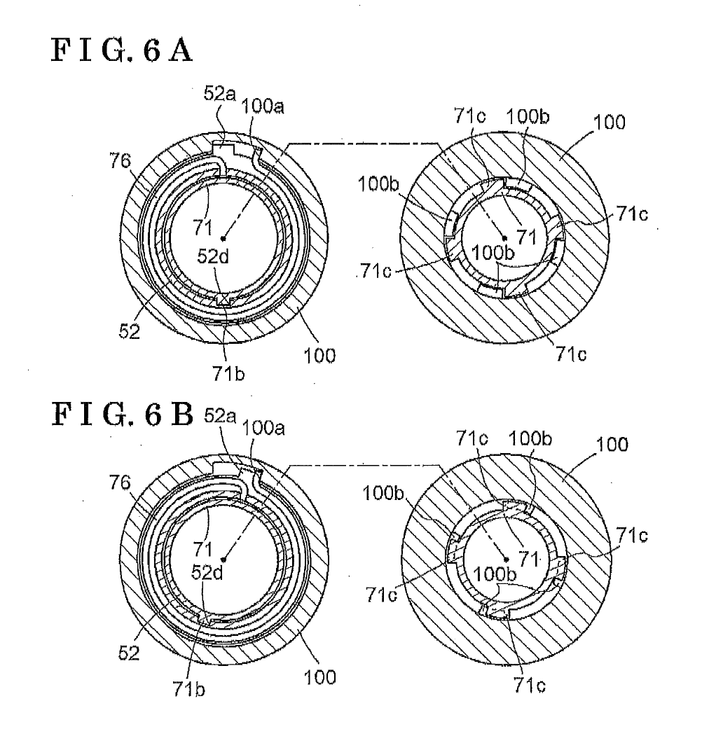

FIGS. 6A and 6B are cross sections of the pressuring mechanism A seen in an axial direction thereof. As illustrated in the cross sections of FIGS. 2, 6A and 6B, engaging portions 710 are formed at the first casing 71 so as to protrude outwardly in a radial direction thereof. A torsion spring 76 is provided in order bias the first casing 71. The right drawings of FIGS. 6A and 6B are cross sections at a position where the engaging portions 71c are provided, and the left drawings of FIGS. 6A and 6B are cross sections at a position where the torsion spring 76 is provided. As indicated in FIGS. 6A and 6B, the housing 100 includes engaged portions 100b with which the engaging portion 71c of the first casing 71 engages in order to regulate the first casing 71 so as not to move forward. As illustrated in FIG. 2, the first casing 71 includes a thrust engagement portion 71b thrust engaging with the linearly moving member 52 in order to receive the rotational force of the linearly moving member 52 by contacting a rotational force transmitting portion 52d formed at the linearly moving member 52.

FIG. 6A illustrates a condition where the motor M is not actuated. In this condition, the first casing 71 is biased by the torsion spring 76 in an anticlockwise direction in FIG. 6A, and the engaging portion 71c is not engaged with the engaged portion 100b. Thus, the first casing 71 is movable in the front direction, in other words the stroke simulator 70 is movable in the front direction. Further, in this condition, and in a case where the motor M is not actuated when the brake pedal BP is pressed by the driver, the stroke simulator 70 is moved forward together with the input rod 44 without generating a reaction force. At this point, because the input rod 44 is connected to the output piston 43 by means of the clutch mechanism 60 as described above, the output piston 43 is moved forward so that the end portion of the master piston 31 is pushed. Accordingly, only the reaction force of the master piston 31 is transmitted to the brake pedal BP.

On the other hand, when the motor M is actuated, the linearly moving member 52 starts its rotation in accordance with the rotation of the rotating member 51. As indicated in the cross sections of FIG. 6B, when the linearly moving member 52 is rotated, the thrust engagement portion 52a contacts the rotation regulating portion 100a so that the linearly moving member 52 is regulated so as not to rotate. At this point, the rotation of the linearly moving member 52 is transmitted to the first casing 71 via the rotational force transmitting portion 52d and the thrust engagement portion 71b, and when the transmitted rotational force overcomes the biasing force of the torsion spring 76, the first casing 71 is rotated. In accordance with the rotation of the first casing 71, the engaging portion 71c engages the engaged portion 100b, as a result, the first casing 71 is regulated so as not to be moved forward. Further, at this point, because of the input rod 44 is disengaged from the output piston 43 by means of the clutch mechanism 60 so as to be independently movable, the input rod 44 does not receive the reaction force from the output piston 43. Thus, only the reaction force generated by the stroke simulator 70 is transmitted to the brake pedal BP.

Thus, according to the brake apparatus In the embodiment, the stroke simulator 70 is fixed to the housing 100 when the motor M is actuated and is disengaged from the housing 100 when the motor M is not actuated. Specifically, when the motor M is actuated, the stroke simulator 70 generates the reaction force, and when the motor M is not actuated, the stroke simulator 70 does not generate the reaction force. Accordingly, when the motor M is not actuated, an undesirable operation force for generating reaction force by the stroke simulator 70 is not required.

According to the brake-by-wire type brake apparatus in the embodiment, the battery BT may continue to supply the electric current to the motor M in order to maintain the level of the braking force even when the brake pedal BP is not pressed, however, this situation is unfavorable in view of power consumption saving. Accordingly, the brake apparatus according to the embodiment includes a ratchet 102 for regulating the motor M so as not to rotate in an opposite direction, thereby maintaining the level of the braking force even when the power supply to the motor M is stopped. The ratchet 102 includes a gear 102a and a pawl 102b. The gear 102a has an axis identical to the rotation shaft of the motor M and rotates integrally with the motor M, and the pawl 102b engages with teeth of the gear 102a in order to regulate the motor M so as not to rotate in the opposite direction. Further, the pawl 102b is pivotally supported by a shaft that has an axis extending in a direction identical to that of the axis of the rotation shaft of the motor M. The pawl 102b is arranged in such a way that one end portion of the pawl 102b engages the tooth of the gear 102a, and the other end portion of the pawl 102b is connected to a solenoid 103. The solenoid 103 includes a movable core being reciprocated by the electric current supplied from the control means B. The control means B supplied the electric current to the solenoid 103 when the braking force needs to be maintained, thereby moving forward the movable core of the solenoid 103. In accordance with the movement of the movable core of the solenoid 103, the pawl 102b pivots so as to be engaged with the teeth of the gear 102a, thereby regulating the gear 102a so as not to rotate in the opposite direction, at the same time regulating the rotating shaft of the motor M so as not to rotate in the opposite direction. Accordingly, when the motor M is stopped, even when a force acting in a pressure decreasing direction is generated by the hydraulic pressure within the master cylinder 30, because the force may be received by the ratchet 102, the level of the hydraulic pressure within the master cylinder 30 may be maintained.

[An Actuation of the Brake Apparatus when the Motor is Normally Actuated]

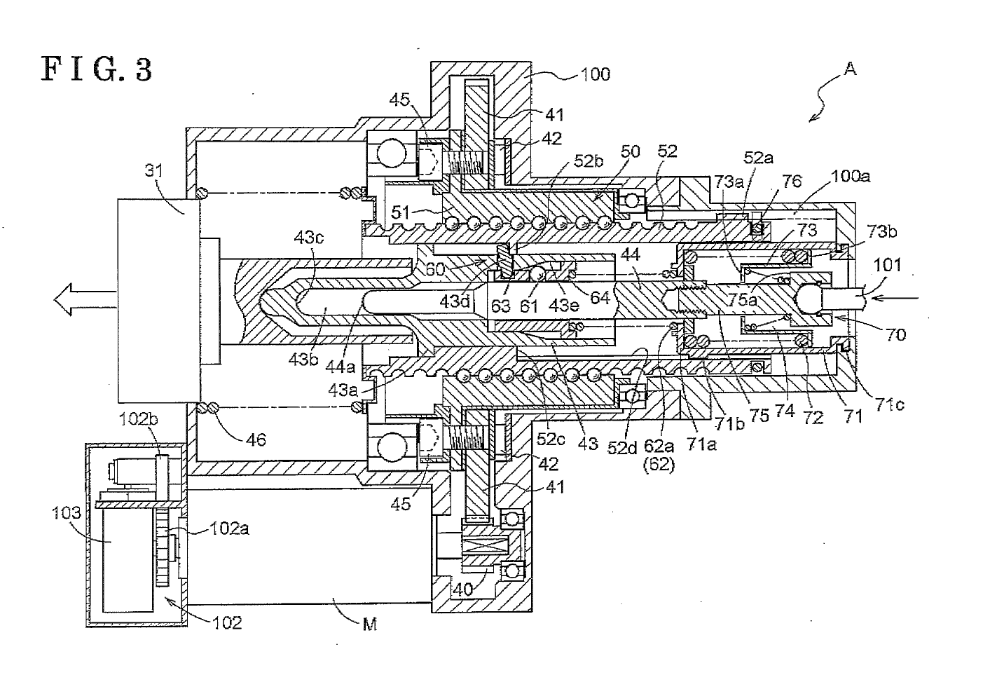

An actuation of the brake apparatus in the embodiment when the motor M is normally actuated will be explained. A drawing in FIG. 3 illustrates a cross section of the pressuring mechanism A when the driver executes a pressing operation of the brake pedal BP.

When the driver executes the pressing operation to the brake pedal BP, a stroke amount and/or a pedal pressure is measured by means of the brake operation sensor BS. The measured value is send to an ECU from the brake operation sensor BS. The ECU controls the motor driver MD to supply an electric current corresponding to the measured value to the pressurizing mechanism A, thereby a braking force corresponding to the measured value may be generated. At this point, braking operation amounts and levels of an electric current and an electric voltage to be supplied are stored, and the stored information may be used in order to determine an amount of the electric current without any calculation.

The motor M of the pressurizing mechanism A to which an electric current is supplied by the motor driver MD rotates corresponding to the supplied electric current. As described above, because the first spur gear 40 is integrally rotated with the rotation shaft of the motor M, the first spur gear 40 rotates at the rotation amount identical to that of the motor M. At this point, the second spur gear 41 having teeth engaging with the teeth of the first spur gear 40 rotates corresponding to the rotation of the first spur gear 40. As described above, because the number of the teeth of second spur gear 41 is greater than that of the first spur gear 40, the first spur gear 40 and the second spur gear 41 function as a rotation speed reduction mechanism.

Further, because the rotating member 51 rotates integrally with the second spur gear 41 and is provided so as not to move in the reciprocating direction of the master piston 31, the rotating member 51 rotates in the same manner as the second spur gear 41 rotates. Further, because the internal thread formed on the rotating member 51 and the external thread formed on the linearly moving member 52 are screwed together, the linearly moving member 52 starts its rotation corresponding to the rotation of the rotating member 51. When the linearly moving member 52 slightly rotates, the thrust engagement portion 52a of the linearly moving member 52 contacts the rotation regulating portion 100a of the housing 100, thereby regulating the linearly moving member 52 so as not to rotate. At this point, the first casing 71 of the stroke simulator 70 rotates so as to be engaged with the housing 100. Thus, the stroke simulator 70 generates a reaction force corresponding to the pressing operation to the brake pedal BP by the driver. Then, the linearly moving member 52 moves forward corresponding to the rotation of the rotating member 51 with compressing the elastic member 46.

The linearly moving member 52 is moved forward so as to close the clearance between the thrust force transmitting portion 52c of the linearly moving member 52 and the thrust force receiving portion 43a of the output piston 43. Then, the output piston 43 moves forward together with the linearly moving member 52 by receiving the thrust force of the linearly moving member 52 moving forward via the thrust force transmitting portion 52c and the thrust force receiving portion 43a.

At this point, the end portion of the master piston 31 extending within the pressurizing mechanism A is pressed by the end portion of the output piston 43. Accordingly, the hydraulic pressure within the hydraulic pressure circuit 10 is increased, and the wheel cylinder WC applies the breaking force to the wheel W by use of the hydraulic pressure of the wheel cylinder WC.

An actuation of the clutch mechanism 60 at this point is indicated in the drawing of FIG. 5B. When the linearly moving member 52 starts moving forward, the inwardly protruding portion 52b formed at the linearly moving member 52 presses one end portion of the link member 63 in the front direction, the one end portion of the link member 63 (e,g., a upper end portion in FIG. 5B) being formed so as to protrude toward the linearly moving member 52. Accordingly, the other end portion of the link member 63 (e.g., a lower end portion in FIG. 513) is pivoted in the rear direction, thereby moving the rotating body 61 so as to be distant from the tapered surface 43e against the biasing force of the biasing body 62. Thus, the input rod 44 and the output piston 43 are disconnected, accordingly the input rod 44 and the output piston 43 may move forward independently.

In this configuration, the function of the brake-by-wire type brake apparatus may be completed while providing an appropriate reaction force to the driver.

Further, as indicated in FIG. 3, when the braking operation is executed, a clearance is formed between the bottom surface 43c of the hollow portion 43b of the output piston 43 and an end portion 44a of the input rod 44. Because of the clearance, even when a regenerative control, an anti-lock brake system control (ABS control) or the like is executed, the end portion 44a may not be pressed by the bottom surface 43c. In other words, when the regenerative control or the ABS control is executed, the reaction force transmitted to the output piston 43 from the master piston 31 may not be transmitted to the input rod 44, and the thrust force of the input rod 44 may not be transmitted to the master piston 31 via the output piston 43. Accordingly, unnecessary reaction force may not be provided to the driver, an operational feeling of the driver may not be deteriorated, and an undesirable regenerative control deteriorated due to the transmission of the driver's operational force may not occur.

[An Actuation of the Brake Apparatus when the Motor is not Normally Actuated]

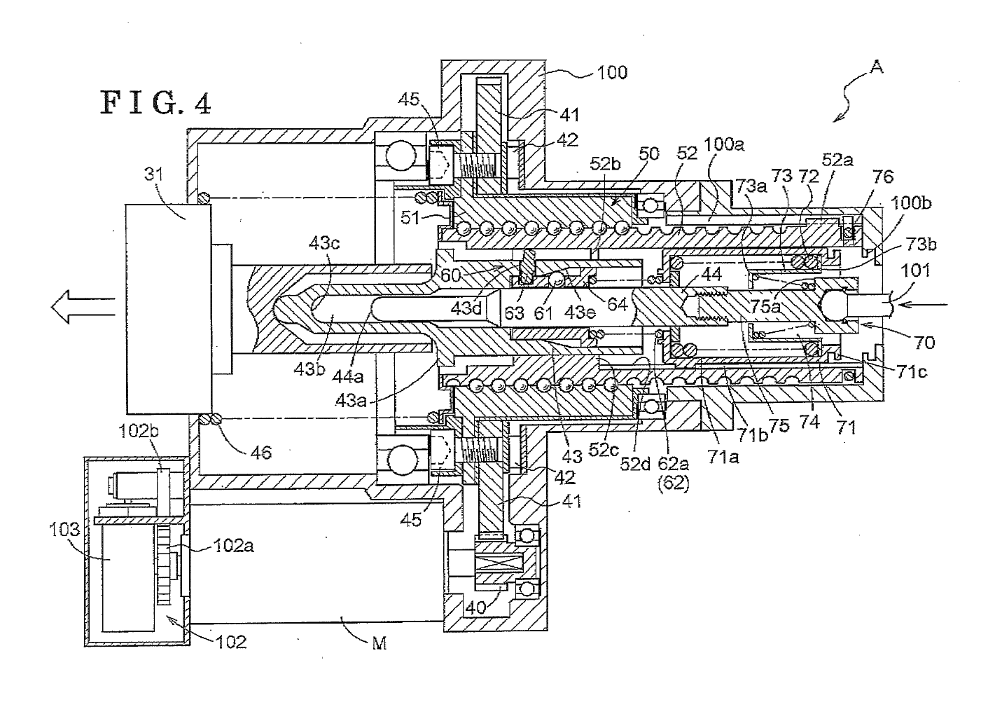

The drawing of FIG. 4 is a cross section of the pressurizing mechanism A in a case where the motor M is not actuated when the braking operation is executed.

When a pressing operation is applied to the brake pedal BP by the driver, an operation amount at the brake pedal BP is measured by the brake operation sensor BS, and the measured operation amount is sent to the ECU. The ECU applies an electric current corresponding to the measured operation amount to the pressurizing mechanism A by means of the motor driver MD, however, the motor M does not rotate.

At this point, as indicated in the drawings of FIG. 6A, the first casing 71 is disengaged from the housing 100 because of the biasing force of the torsion spring 76, and the stroke simulator 70 is movable forward.

In the embodiment, because an installation load of the biasing body 62 is set to be greater than that of the second elastic member 74, when the shaft 101 is moved forward corresponding to the pressing amount to the brake pedal BP, the second elastic member 74 starts being compressed first, and then the first casing 71 of the stroke simulator 70 starts moving forward. Even when the drive of the motor M is delayed due to a time lag or the like, if the actuation of the motor M is started before the first casing 71 of the stroke simulator 70 is moved forward, the first casing 71 engages the housing 100 on the basis of the rotation of the motor, and the mechanism is normally actuated as described above.

Further, when the motor M is not rotated after the input rod 44 starts moving forward, as indicated in the drawing of FIG. 5A, the rotating body 61 is biased by the tapered surface 43e and the side surfaces of the input rod 44 by the biasing force of the biasing body 62, as a result, the connecting condition between the input rod 44 and the output piston 43 is maintained. Accordingly, the force of the shaft 101 moving forward is transmitted to the input rod 44, and then the output piston 43 connected to the input rod 44 by means of the clutch mechanism 60 is moved forward together with the input rod 44. At this point, the end portion of the output piston 43 presses the master piston 31, thereby increasing the pressure of the brake fluid.

Thus, when the motor M is not normally actuated, the force of the pressing operation to the brake pedal BP is directly transmitted to the output piston 43, thereby increasing the pressure of the brake fluid. Further, because the stroke simulator 70 is movable independently from the housing 100 and is integrally moved forward together with the input rod 44, the stroke simulator 70 may not generate a reaction force. In other words, the driver receives only the reaction force froth the brake fluid generated when the master piston 31 is moved forward, and the operation force to the brake pedal BP may be converted to all of the braking force used for operating the brakes.

According to the brake-by-wire type brake apparatus, the pedal pressure of the brake pedal BP is converted to the electric signal and transmitted to the motor M, and the motor M generates the braking force. Accordingly, an inspection whether or not the motor M is correctly actuated is important. According to the known brake apparatus, various sorts of parts are inspected by an initial-check before the vehicle moves, however, because failure probability may be increased depending on a traveling time, a traveling mile and a number of operations, it may be described that the failure probability is increased while the vehicle is traveling rather than it is stopped. Further, since a possibility that the failure of the brake apparatus leads to a serious accident is high, it is necessary for the brake apparatus that the failure of the brake apparatus while the vehicle is traveling is detected. In order to detect the failure of the motor M of the brake apparatus (e.g., the motor M fails to operate properly), the brake apparatus in the embodiment further includes a failure determining means. In the embodiment, the control means B functions as the failure determining means, however, the failure determining means may be provided independently.

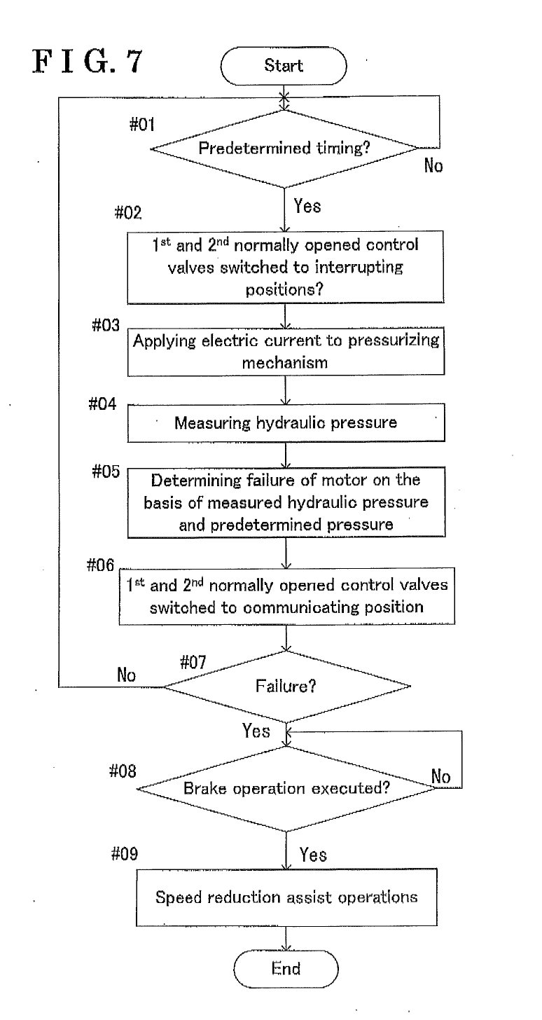

A control of the brake apparatus according to the embodiment will be explained in accordance with a flowchart of FIG. 7. The brake apparatus in the embodiment executes a failure determination of the motor M at predetermined timings. When the predetermined timings are confirmed, the failure determination proceeds to the control flow of FIG. 7.

The predetermined timings are set at following various points in time. (1) A timing where a level of dangerousness exceeds a threshold. (2) A timing determined on the basis of a time period since a previous braking operation or a previous failure determining control occurred. (3) A timing determined on the basis of a traveling time and a distance since the previous braking operation or the previous failure determining control occurred. (4) A timing determined on the basis of values measured by sensors for detecting a temperature, an electric current, an electric voltage, an addition-subtraction speed, humidity and the like. (5) A timing determined on the basis of a predetermined time period. In case (1), it is determined that a level of dangerousness is high in a case where a measured vehicle speed is higher than a predetermined speed, or a measured distance between the vehicle and a vehicle traveling ahead is less than a predetermined distance. When the level of dangerousness is high, the failure determination control is executed. In case (2), the timing may preferably be set at immediately after the braking operation and the failure determining control because the rate of failure may be increased at those points. In case (5), because the control may preferably be executed during the braking operation, the predetermined time period may be set to several minutes.

The control means B determines whether or not a current timing is a predetermined timing (#01). When the control means B determines the current timing is the predetermined timing (Yes in #01), the first normally opened control valves 12a and 12b and the second normally opened control valves 16a and 16b are switched to interrupting positions (#02), thereby each of the wheel cylinders WC is disconnected from the master cylinder 30.

Then, the control means B applies a desired electric current to the pressurizing mechanism A in order to increase the hydraulic pressure within the master cylinder 30 so as to be a predetermined pressure (#03). As described above, by means of the pressurizing mechanism A to which the electric current is applied, the hydraulic pressure of the hydraulic pressure circuit 10 is increased by the master piston 31 being pressed by the rotations of the motor M.

At this point, the hydraulic pressure of the second hydraulic pressure circuit 10b is measured by means of the master cylinder hydraulic pressure sensor 24, and the measured pressure is transmitted to the control means B (#04). The control means B determines a failure of the motor M on the basis of a comparison between the measured hydraulic pressure and a predetermined pressure. In other words, when a difference between the measured hydraulic pressure and the predetermined pressure is a threshold or less, the control means B determines that the motor M is normally actuated, and when the difference between the measured hydraulic pressure and the predetermined pressure exceeds the threshold, the control means B determines that the motor M fails to operate properly (#05). According to this determining method, even when the motor M is normally actuated, the control means B incorrectly detects that the motor M fails to operate properly in a case where the master cylinder hydraulic pressure sensor 24 fails to operate properly. However, in a case where the master cylinder hydraulic pressure sensor 24 falls to operate properly, because the brake system itself fails to operate properly, the incorrect detection may not lead to any malfunction. A rotation sensor for measuring a rotation amount (e.g. a rotation angle) of the motor M may be provided, and the failure of the motor M may be determined on the basis of the hydraulic pressure and the rotation amount of the motor M. Thus, the failure of the motor M may be distinguished from other failures by the failure detection on the basis of the hydraulic pressure and the rotation amount of the motor M.

After obtaining the measured pressure and the measured rotation amount, the control means B switches the first normally opened control valves 12a and 12b and the second normally opened control valves 16a and 16b to the communicating position for another braking operation to be followed (#06). In a case where a braking operation is executed during the abovementioned process, the failure determination control is interrupted, and the valves are switched to the communicating position at this point.

The control means B determines that the motor M does not fail to operate in #05 (No in #07), the processes #01 through #07 are repeated at the predetermined timing. On the other hand, the control means B determines that the motor M falls to operate properly (Yes in #07), and then the braking operation is executed (Yes in #08), the control means B executes various kinds of speed reduction assist operations. Specifically, the control means B further includes braking assist control means, and the braking assist control means executes the speed reduction assist operations such as a shift down operation of a transmission, an operation for shutting down a fuel supply to an engine, an operation for actuating an electric parking brake and/or the like, thereby safely stopping the vehicle (#09). Furthermore, when the control means B determines that the motor M fails to operate properly (Yes in #07), the control means B may notify the failure to the driver, accordingly the driver is then aware that the brake apparatus needs to be operated by applying more pressure to the brake pedal than usual.

The abovementioned structure and/or control may be applied to a brake apparatus in which a pressure applied to a brake pedal is converted to an electric signal and a hydraulic pressure is generated in a master cylinder so as to correspond to the electric signal in order to apply a braking force to wheels.

In this configuration, when the failure determination is executed, an electric current corresponding to the desired hydraulic pressure is applied to the motor, and the failure of the motor is determined on the basis of the hydraulic pressure measured by the hydraulic pressure sensor. At this point, because the electric current is applied to the motor, and the valves are set to the interrupting positions in order to interrupt the passages, even when the motor is operated correctly, the hydraulic pressure generated within the master cylinder is not transmitted to the braking mechanism, as a result, the braking force is not generated. Thus, even when the vehicle travels, the failure of the motor is determined by applying the electric current to the motor.

In this configuration, when the failure determination is executed, because the rotation sensor detects the rotation amount of the motor, it may be determined whether or not the failure source is the motor. For example, the failure determining means determines that the failure source is the motor when the measured value of the hydraulic pressure sensor is normal but the rotation amount of the rotation sensor is abnormal. In this case, the failure determining means may determine that the failure is not caused by the motor, but caused by, for example air entering the circuit.

In this configuration, when the failure of the motor is determined, while a braking operation is executed after the failure determination, the braking assist control means executes the speed reduction assist operations. Accordingly, a speed reduction of the vehicle may be safely executed even when the brake apparatus is not correctly operated.

The principles, preferred embodiment and mode of operation of the present invention have been described in the foregoing specification. However, the Invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A brake apparatus comprising:
a master cylinder generating a master cylinder hydraulic pressure corresponding to a pressing operation to a brake pedal;
a braking mechanism applying a braking force to a wheel by use of the master cylinder hydraulic pressure;
a pressurizing mechanism generating a brake fluid pressure by use of a motor irrespective of the pressing operation to the brake pedal and applying the brake fluid pressure to the braking mechanism;
control means controlling an electric current applied to the motor corresponding to the pressing operation to the brake pedal;
a valve controlling a flow of the brake fluid pressure to the braking mechanism so as to be communicated or interrupted;
a hydraulic pressure sensor detecting the brake fluid pressure generated by the pressurizing mechanism; and
failure determining means executing a failure determination of the motor on the basis of the brake fluid pressure detected by the hydraulic pressure sensor by adjusting the degree of opening of the valve so as to be a interrupting position for interrupting the flow of the brake fluid pressure and by applying an electric current to the motor in order to generate the brake fluid pressure so as to be a predetermined pressure.

2. The brake apparatus according to claim 1, wherein the pressurizing mechanism includes an output piston provided so as to be movable in an axial direction thereof by the motor in order to generate the master cylinder hydraulic pressure, and the brake fluid pressure generated by the pressurizing mechanism is applied to the braking mechanism via the master cylinder.

3. The brake apparatus according to claim 2 further includes a brake operation sensor detecting a level of the pressing operation to the brake pedal, and the failure determining means starts the execution of the failure determination when the brake operation sensor detects that the brake pedal has not operated for a predetermined time period.

4. The brake apparatus according to claim 2 further includes a brake operation sensor detecting a level of the pressing operation to the brake pedal, and when the brake operation sensor detects that the pressing operation to the brake pedal is completed, the failure determining means starts the execution of the failure determination immediately after the pressing operation to the brake pedal is completed.

5. The brake apparatus according to claim 1 further includes a rotation sensor for detecting a rotation amount of the motor, and the failure determining means determines the failure of the motor on the basis of the brake fluid pressure detected by the hydraulic pressure sensor and the rotation amount of the motor detected by the rotation sensor.

6. The brake apparatus according to claim 1 further includes braking assist control means, and when the pressing operation is executed to the brake pedal after the failure determining means determines the failure of the motor, the braking assist control means executes at least one of a shift down operation of a transmission, an operation for shutting down a fuel supply to an engine and an operation for actuating an electric parking brake.
